(19) United States
(12) Patent Application Publication
(10) Pub. No.: US 2013/0160864 A1
(43) Pub. Date: Jun. 27, 2013

(54) Brake Bleeding

(71) Applicant: Nigel Alexander Buchanan, New Gilston (GB)

(72) Inventor: Nigel Alexander Buchanan, New Gilston (GB)

(21) Appl. No.: 13/820,504

(22) PCT Filed: Sep. 1, 2011
(86) PCT No.: PCT/GB11/51646

§ 371 Date: Mar. 1, 2013

(30) Foreign Application Priority Data
Sep. 1, 2010 (GB) 1014515.9

(51) Int. Cl. B60T 17/22

(52) U.S. Cl. CPC B60T 17/222
USPC 137/15.01; 137/565.17

(57) ABSTRACT

A brake bleeding kit includes a first part 214 to be fitted to a brake fluid container 212, a second part 216 to be fitted to a master cylinder reservoir (252) of a brake system and tubing (218) to connect the first part and second part to transfer brake fluid from the container to the master cylinder reservoir via the first and second parts.

### RELATED APPLICATION DATA

This application claims the benefit of PCT Application PCT/GB2011/051646 with an International Filing Date of Sep. 01, 2011, published as WO 2012/028885 A1, the entire contents of which are hereby incorporated by reference.

### BACKGROUND OF THE INVENTION

1. Field of the Invention

The invention relates to brake bleeding.

2. Description of Related Art

It is known to bleed the brake system of a motor vehicle by opening the master cylinder reservoir, connecting a tube to a bleed nipple on a brake unit of the brake system and putting the free end of the tube into a collecting receptacle, opening the bleed nipple and then pumping the brake to expel brake fluid from the brake system into the receptacle. The reservoir is periodically filled with fresh fluid to ensure that air is not drawn into the system and provide a source of fresh fluid to fill the system. Filling is achieved by pouring the brake fluid from a container of brake fluid, which will typically be a metal can. Each brake of the brake system is treated this way in sequence to bleed the entire brake system.

### SUMMARY OF THE INVENTION

The invention provides a brake bleeding kit comprising a first part to be fitted to a brake fluid container, a second part to be fitted to a master cylinder reservoir of a brake system and tubing to connect the first part and second part to transfer brake fluid from said container to said master cylinder reservoir via said first and second parts.

The invention also includes a method of bleeding a brake system using a kit as specified in the last preceding paragraph, the method comprising connecting a brake fluid container to a master cylinder reservoir by fitting said first part to said brake fluid container and said second part to a said master cylinder reservoir and causing brake fluid to be expelled from said container to said reservoir.

The invention also includes a holder for a brake fluid container comprising a flexible body through which the brake fluid container can be squeezed. The holder may comprise an opening for a tube extending from a part fitted to said brake fluid container. The holder may comprise a connecting portion by which it can be connected to an object by suspension therefrom. The holder may comprise a body portion comprising a generally rectangular tube. The holder may be configured to hold a 1 liter brake fluid container.

The invention also comprises a brake bleeding kit comprising a first cap to be sealingly fitted over an opening of a brake fluid container, a second cap to be sealingly fitted to an inlet of a master cylinder reservoir and a ducting system to connect between said first and second caps to transfer brake fluid from said brake fluid container to said master cylinder reservoir via said first and second caps.

The invention also includes a method of bleeding a vehicle brake system, said method comprising providing ducting between a brake fluid container and a master cylinder reservoir of said brake system, providing a first sealed connection between an opening of said brake fluid container and said ducting, providing a second sealed connection between said master cylinder reservoir and said ducting, compressing said brake fluid reservoir to generate a pressure increase in said ducting and opening a bleed valve of said brake system whereby brake fluid is drawn from said brake fluid container to said master cylinder reservoir. The method may comprise breaking said first sealed connection faster generating said pressure increase.

### BRIEF DESCRIPTION OF THE DRAWINGS

In order that the invention may be well understood, an embodiment thereof, which is given by way of example only, will now be described with reference to the drawings in which:

FIG. 1 is a perspective view of a holder holding a brake fluid container;

FIG. 2 is a perspective view corresponding to FIG. 1 with the holder omitted to show the orientation of the brake fluid container in the holder;

FIG. 3 is a perspective view of a cap and tube fitted to the brake fluid container of FIG. 2;

FIG. 4 is a side view of a master cylinder cap;

FIG. 5 is a perspective view of the master cylinder cap;

FIG. 6 is a schematic illustration of a motor vehicle during a brake bleeding process;

FIG. 7 is a schematic view of a wheel and brake unit of the motor vehicle;

FIG. 8 is a perspective view showing another holder in an open condition;

FIG. 9 is a side view of yet another holder holding a brake fluid container;

FIG. 10 is a front view of the holder and brake fluid container of FIG. 9; and

FIG. 11 is a schematic representation showing the brake fluid container of FIGS. 9 and 10 connected with a master cylinder reservoir of a brake system.

### DETAILED DESCRIPTION OF THE ILLUSTRATED EMBODIMENTS

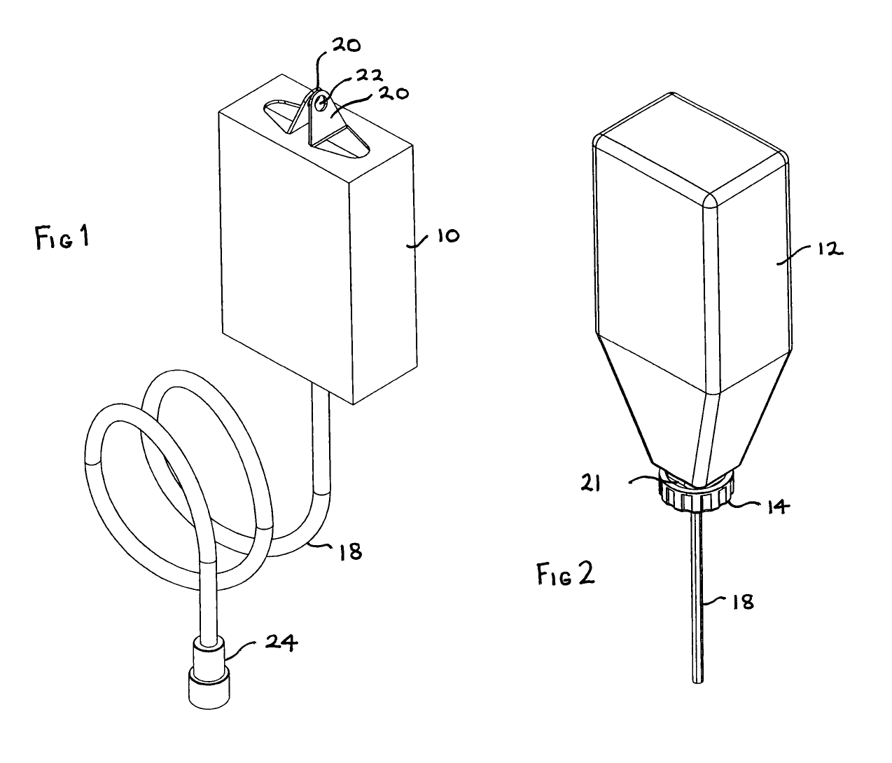

Referring to FIGS. 1 to 5, a brake bleeding kit, or system, comprises a holder 10 for a container 12 of brake fluid, a cap 14 for fitting to the container 12, a master cylinder cap 16 and tubing 18 to connect the caps 14, 16.

The holder 10 comprises a generally rectangular hollow body in which the container 12 can be received. The holder 10 is provided with at least one ear 20 that has an aperture 22. The illustrated holder 10 has two ears 20. However, the holder 10 could be provided with just one ear or more than two as required. The holder 10 can be suspended from a suitable location to allow brake fluid to be dispensed from the brake fluid container 12 by tying a piece of string, cord or wire through the aperture(s) 22.

The brake fluid container 12 is standard one litre plastics bottle filled with brake fluid as supplied by a brake fluid supplier. Those skilled in the art will be familiar with such containers, which as shown in FIG. 2 typically have a rectangular body that tapers to the neck 21 of the container, which defines an open end of the container through which brake fluid can be dispensed. The cap 14 is provided with internal threading (not shown) to allow it to be screwed onto and seal against the neck 21 of the container 12 in place of the container's own closure cap. The cap 14 has an aperture through which the tubing 18 extends into the interior of the container 12. The end of the tubing 18 remote from the cap 14 is fitted with a push-fit connector 24 (FIG. 1).

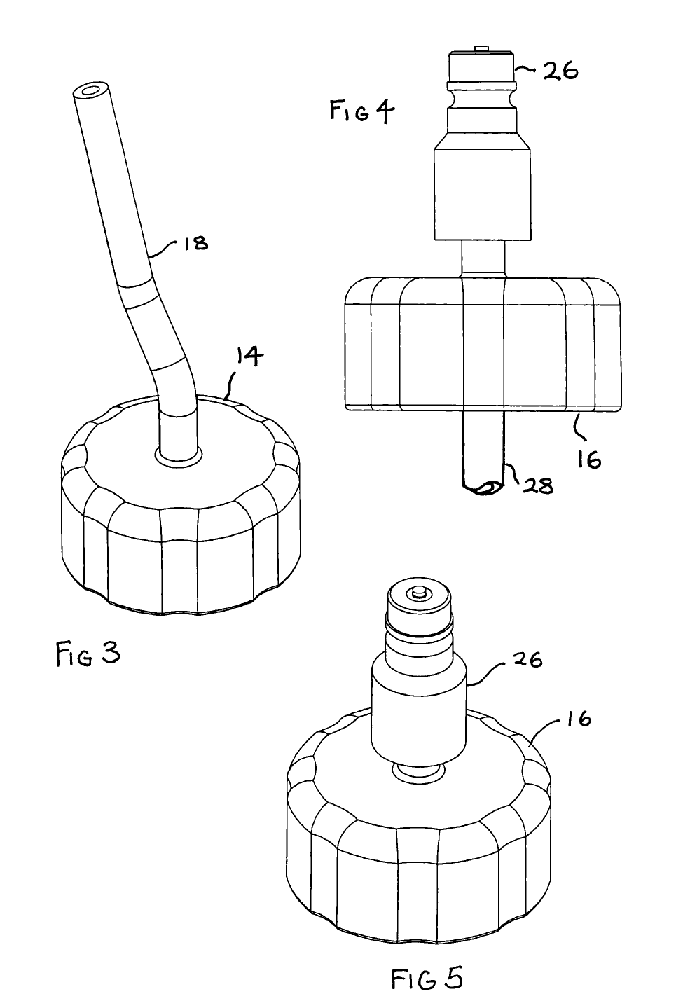

Referring to FIGS. 4 and 5, the push-fit connector 24 is configured to be releasably push-fitted onto a spigot 26 provided on the master cylinder cap 16, which may be one of a plurality of different master cylinder caps provided in the kit. The master cylinder cap 16 has internal threading to allow it to be screwed onto the tubular threaded inlet of a master cylinder reservoir to form a sealed connection with the master cylinder reservoir. The master cylinder cap 16 is provided with an outlet duct, or tube 28 that is in flow communication with the spigot 26 to receive brake fluid from the tubing 18. The outlet tube 28 is configured to extend into the master cylinder reservoir below the designed fill level so that during a brake bleeding process the free end of the tube will be submerged in brake fluid.

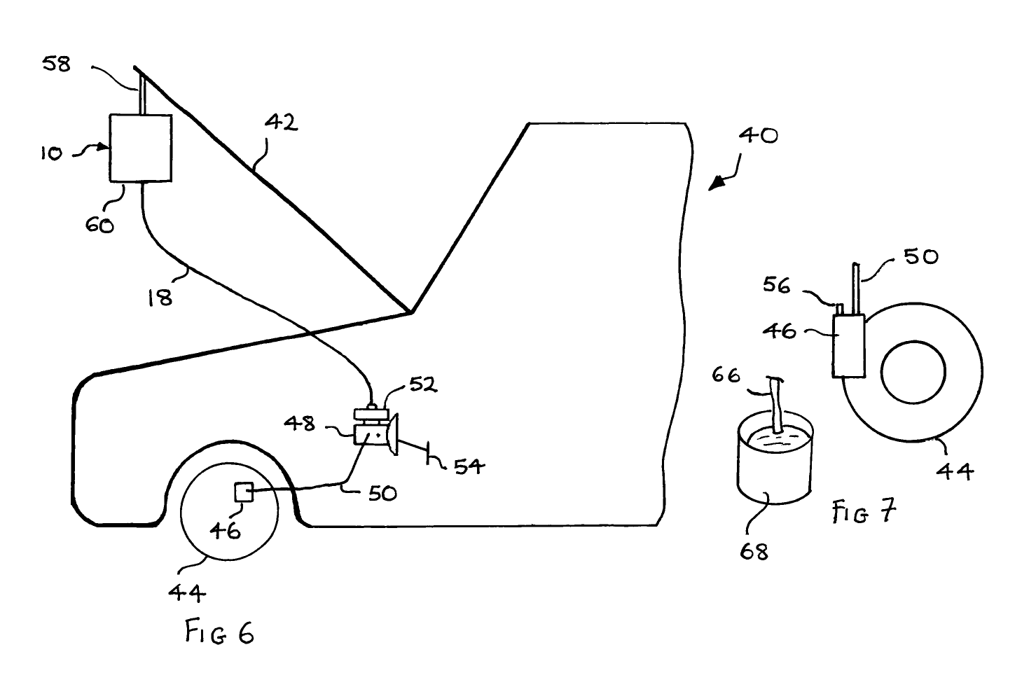

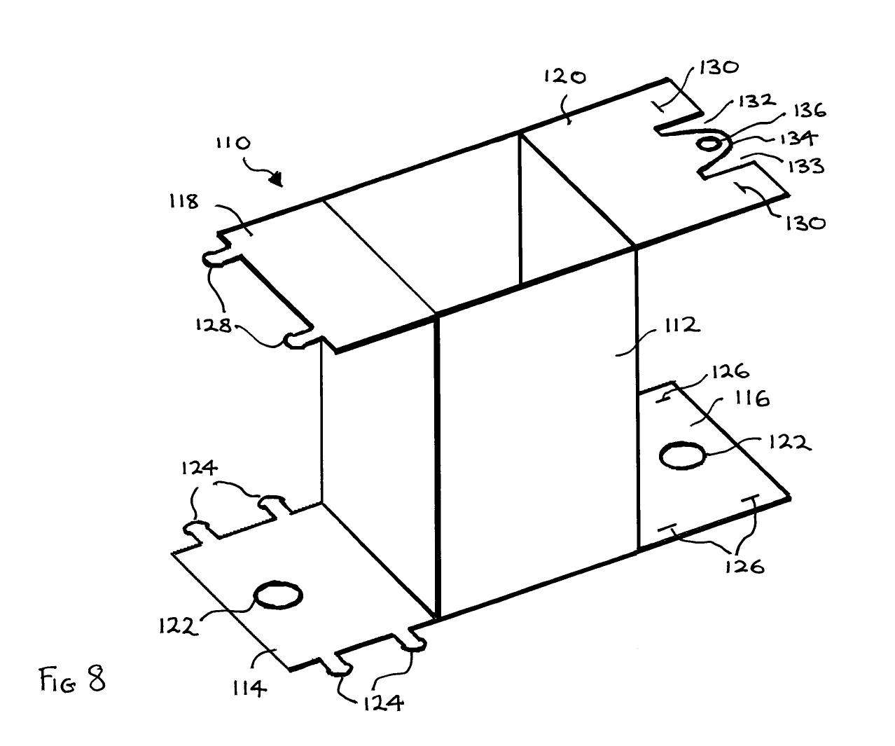

Use of the brake bleeding kit illustrated in FIGS. 1 to 5 will now be described with reference to FIGS. 6 and 7. A motor vehicle 40 is shown with its bonnet (hood) 42 in a raised condition. The motor vehicle 40 comprises a wheel 44 fitted with a brake unit 46. The brake unit 46 is connected with a master cylinder 48 by ducting 50. The master cylinder 48 is provided with a master cylinder reservoir 52 to contain a supply of brake fluid. The master cylinder 48 is also connected with a brake pedal 54 by means of which a driver can pressurise the brake fluid in the motor vehicle's braking system in order to operate the brake unit 46, which is typically one of a set of brake units that are provided on respective wheels of the motor vehicle. The brake unit 46 is provided with a bleed nipple 56.

A holder 10 is shown suspended from the free end of the bonnet 42 by a cord, wire or string 58 that is threaded through the apertures 22 of the ears 20 (FIG. 1). A brake fluid container 12 is held in the holder 10. A cap 14 has been fitted to the container 12 in place of the usual closure cap. FIG. 2 shows the orientation of the container 12 within the holder 10. The neck of the container 12 and cap 14 are at the lower end 60 of the holder 10 so that the open end of the neck 21 is pointing generally downwardly. The lower end 60 of the holder 10 is provided with an opening (not shown) through which the tubing 18 extends. The tubing 18 extends from the cap 14 on the container 12 to a master cylinder cap 16 that has been fitted to the master cylinder reservoir 52 in place of the usual closure cap. Typically, the master cylinder cap 16 is fitted to the reservoir 52 and then the push-fit connector 24 on the free end of the tubing 18 is fitted to the spigot 26. However, some users may prefer to fit the connector to the spigot 26 before fitting the cap 16 on the reservoir.

Referring to FIG. 7, a tube 66 extends from the bleed nipple 56 to a receptacle 68 that receives spent brake fluid from the brake system.

To bleed the brake system of the vehicle 40, a suitable master cylinder cap 16 is fitted to the master cylinder reservoir 52 in place of the usual closure cap. The tubing 18 is threaded through the opening in the lower end 60 of the holder 10 and connected to the master cylinder cap 16 by push-fitting the push-fit connector 24 to the spigot 26. The cap 14 is then connected to the neck 21 of the brake fluid container 12, which is then inserted into the holder 10. The holder 10 is suspended at a suitably elevated position, such as the free end of the bonnet 42, by a wire, cord, string 58 or the like. The tube 66 is connected to the brake nipple 56 and its free end is inserted into the receptacle 68. With the bleed nipple 56 opened, a flow of brake fluid from the brake fluid container 12 is obtained by squeezing the container through the holder 10. This pumps fresh brake fluid from the brake fluid container 12 into the master cylinder reservoir 52 to force old fluid out of the brake system into the receptacle 68 via the bleed nipple 56. The brake system can be bled to replace the old brake fluid with fresh fluid by systematically opening the bleed nipple of each brake unit of the system.

FIG. 8 shows a modified holder 110 in an open condition. The holder 110 may be made of a flexible sheet material such as a plastics material or cardboard. If cardboard is used, it may be given a plastics or wax coating. The holder 110 comprises a body portion 112 in the form of a rectangular section tube, first end flaps 114, 116 and second end flaps 118, 120.

The first end flaps 114, 116 are provided with respective apertures 122 that are disposed in overlying relationship when the flaps are closed. The flap 114 is provided with barbed fingers 124 that can be fitted into slits 126 provided in the flap 116. The second end flap 118 is provided with barbed fingers 128 that can be fitted into slits 130 provided in the second end flap 120. The flap 120 is provided with a pair of cut-outs 132 that define an ear 134 provided with an aperture 136. The holder 110 differs from the holder 10 only in that it has one ear 134 instead of two. When a brake fluid container 12 is fitted into the holder 110, the tubing 18 projects through the overlying apertures 122 and the holder can be suspended by means of a piece of string, wire or cord passing through the aperture 136 provided in the ear 134.

A brake bleeding kit that allows the brake fluid container to be used while in an upright configuration will now be described with reference to FIGS. 9 to 11. Parts similar to or the same as parts of the brake bleeding kit shown in FIGS. 1 to 5 will be referenced by the same reference numeral incremented by 200 and may not described in detail again.

Referring to FIGS. 9 and 11, the brake bleeding kit comprises a holder 210 for a brake fluid container 212. The holder 210 is a rectangular body having a closed lower end 260 and an open upper end 272. An ear or back member 220 extends from the upper end 272 on one side of the body. The ear 220 is provided with an aperture 222 through which a string, wire, cord or the like can be threaded to secure the holder to, for example, the bonnet of a motor vehicle. In the illustrated embodiment, the kit is show provided with a generally S-shaped hook. The holder 210 is made from a flexible material such as a plastics material or card. If the holder is made of card, it may be coated with a plastics material or wax.

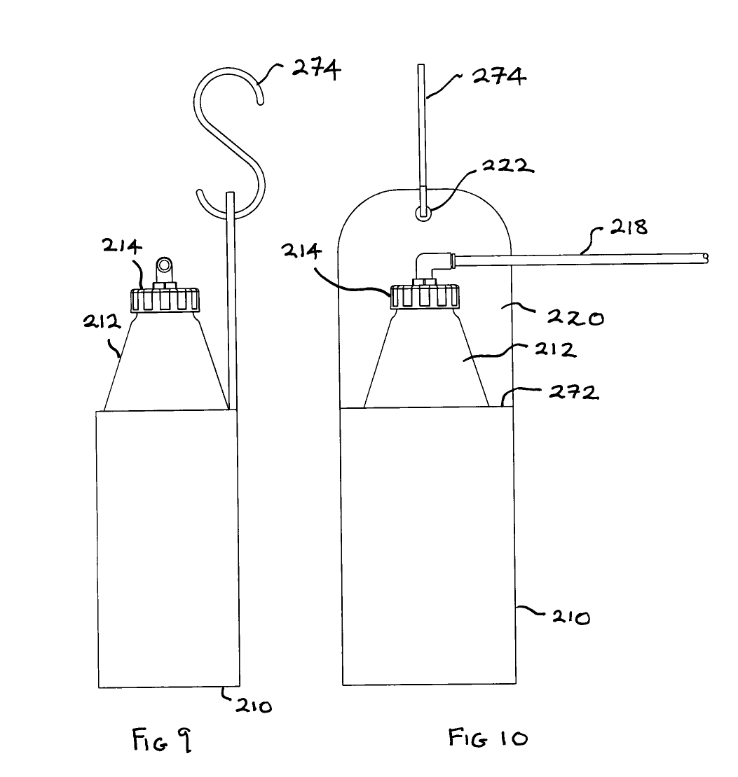

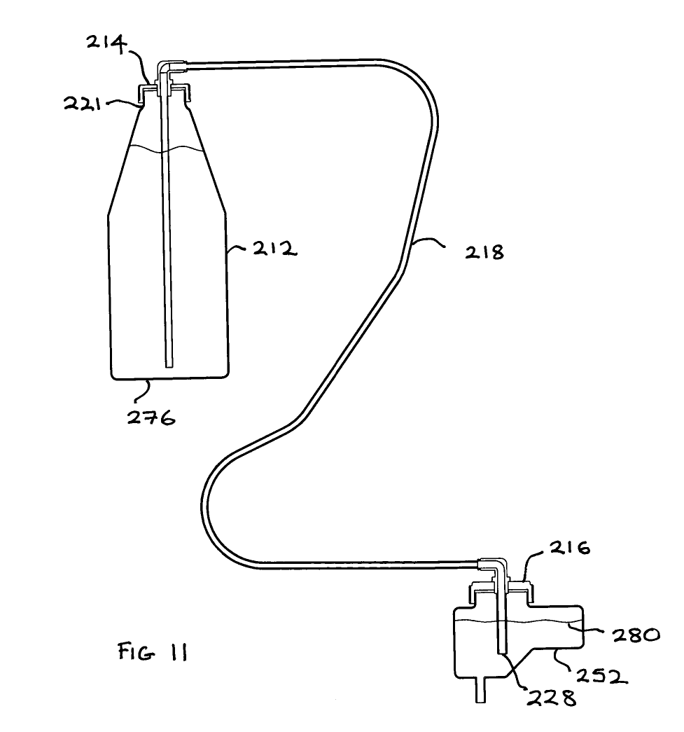

As shown in FIGS. 9 and 10, a brake fluid container 212 can be fitted in the holder 210 with its neck 221 (FIG. 11) pointing generally upwardly. A cap 214 is fitted to the neck 221 of the container 212. Tubing 218 extends from the cap 214 to allow it to be connected to a master cylinder cap 216 (FIG. 11). As shown in FIG. 11, the tubing 218 extends through the cap 214 to a position adjacent the base 276 of the brake fluid container 212.

Unlike the brake bleeding kit shown in FIGS. 1 to 5, the tubing 218 is not provided with a releasable push-fit connector 24 for connecting to the master cylinder cap 216. However, it will be appreciated that a releasable push-fit connection can be provided if desired.

In use of the brake bleeding kit shown in FIGS. 9 to 11, with the caps 214, 216 closed and sealed, the brake fluid container 212 is squeezed through the holder to fill the tubing 218 with brake fluid. If the outlet tube 228 on the master cylinder cap 216 is long enough to extend into the fluid 280 in the master cylinder reservoir 252 the fluid will flow from the brake fluid container 212 when the cap 214 is opened. If not, the cap 214 is opened as the squeeze on the container 212 is released. The resultant fluid head pressure difference between the new fluid in the container 212 and the fluid at the bleed nipple can easily be as much as 27.5 KN/m² (approximately 4 psi). The new fluid is siphons from the brake fluid container 212 as old fluid is expelled via the bleed nipple. Though not needed and possibly undesirable, the brake pedal can be operated in order to accelerate the bleed process.

It may be desirable to incorporate a shut off valve in the tubing that connects the cap on the brake fluid container to the master cylinder cap.

In some embodiments, the cap for fitting to the brake fluid container may be omitted. Instead, a tube connection, for example in the form of a bulkhead fitting, may be provided to fit in a suitably sized hole drilled into the brake fluid container's own cap. Examples of such bulkhead fittings are shown fitted in apertures in the caps 214, 216 in FIG. 11. The bulkhead fittings and tubing comprise a ducting system to connect between the two caps.

It will be understood that the holder does not have to be generally rectangular as shown in the illustrated embodiments and may instead be shaped to conform with the shape of the brake fluid container. For example, the holder may be generally circular in cross section to hold a circular brake fluid container.

The holder may be conveniently formed by folding a sheet material such as a plastics material or card. The folded sheet may include flaps to close at least one end of the holder. The flaps may be provided with formations to permit them to be releasably secured in a closed position. In the embodiment shown in FIG. 8, the formations comprise barbed fingers and slots to receive the fingers.

1. A brake bleeding kit comprising:
a first part to be fitted to an outlet of a brake fluid container;
a second part to be fitted to an inlet of a master cylinder reservoir of a brake system;
tubing to connect the first part and second part to transfer brake fluid from said brake fluid container to said master cylinder reservoir via said first and second parts; and
a holder for said brake fluid container, wherein said holder is configured to be suspended from an elevated location relative to said master cylinder reservoir and to permit squeezing of said brake fluid container to force brake fluid from said container.

2. A brake bleeding kit as claimed in claim 1, wherein said first and second parts are configured to sealingly connect to said brake fluid container outlet and master cylinder reservoir inlet respectively.

3. A brake bleeding kit as claimed in claim 1, wherein said first part and second parts are caps.

4. A brake bleeding kit as claimed in claim 1, wherein said second part is a cap.

5. A brake bleeding kit as claimed in claim 4, wherein said first part is a tube connector to be fitted in a hole formed in a closure member of said brake fluid container outlet.

6. A brake bleeding kit as claimed in claim 3, wherein said second part comprises an outlet duct to be submerged in brake fluid contained in said master cylinder reservoir.

7. A brake bleeding kit as claimed in claim 1, comprising a plurality of said second parts, wherein said plurality of second parts comprises different caps to connect to the respective inlets of different master cylinder reservoirs.

8. (canceled)

9. (canceled)

10. A brake bleeding kit as claimed in claim 1, wherein said holder is provided with an opening in an end thereof through which said tubing can extend to permit said first part to be connected to the outlet of said brake fluid container when held in said holder with said outlet disposed adjacent said end and pointing generally downwardly when in use said holder is suspended from said elevated location.

11. A brake bleeding kit as claimed in claim 1, wherein said holder comprises a tubular body having a least one end closed by a plurality of flaps provided with formations to permit said flaps to be releasably secured in a closed position.

12. A brake bleeding kit as claimed in claim 1, wherein said tubing is provided with a one-way valve.

13. A method of bleeding a brake system using a brake bleeding kit and a brake fluid container containing brake fluid, wherein:
said brake bleeding kit comprises a first part to be fitted to said brake fluid container, a second part to be fitted to a brake master cylinder reservoir, tubing to connect said first and second parts and a holder for said brake fluid container, and
said method comprises:
connecting said brake fluid container to said brake master cylinder reservoir by fitting said first part to an outlet of said brake fluid container and said second part to an inlet of said brake master cylinder reservoir;
fitting said brake fluid container to said holder;
suspending said holder from an elevated location relative to said brake master cylinder reservoir; and
applying a pressure to said brake fluid container through said holder to cause brake fluid to be expelled from said brake fluid container to said brake master cylinder reservoir.

14. (canceled)

15. A method as claimed in claim 13, comprising causing said brake fluid to be expelled from said brake fluid container by compressing said brake fluid container.

16. A method as claimed in claim 15, comprising partially releasing said first part on said outlet of the brake fluid container after compressing said brake fluid container.

17. A method as claimed in claim 13, wherein fitting said first part to said outlet of said brake fluid container comprises making a hole in a closure cap of said brake fluid container and fitting said first part to said hole.

18. A method as claimed in claim 13, wherein fitting said brake fluid container to said holder comprises disposing said brake fluid container in said holder with said outlet facing downwardly in said holder and said first and second parts connected via an aperture in a lower end of said holder.

19. A method as claimed in claim 13, wherein fitting said brake fluid container to said holder comprises fitting said brake fluid container to said holder with said outlet facing upwardly away from a lowermost end of said holder.

20. A method as claimed in claim 13, comprising forming said holder by erecting a folded sheet and closing an end of a body portion of the holder by securing formations of a flap to said body portion.

21. A brake bleeding kit comprising:
a first part to be fitted to an outlet of a brake fluid container;
at least one second part to be fitted to an inlet of a brake master cylinder reservoir;
tubing to connect the first part and second part to transfer brake fluid from said brake fluid container to said brake master cylinder reservoir; and
a folded sheet that can be erected to form a holder for said brake fluid container that is configured to be suspended from an elevated location relative to said brake master cylinder reservoir and permit compression of said brake fluid container through said holder to at least initiate a flow of brake fluid from said brake fluid container to said brake cylinder master reservoir.
